(19) United States
(12) Patent Application Publication
(10) Pub. No.: US 2018/0250739 A1
(43) Pub. Date: Sep. 6, 2018

(54) Additive manufacturing method and apparatus

(71) Applicant: Stichting Energieonderzoek Centrum Nederland, Petten (NL)

(72) Inventors: Jacob Jan Saurwalt, Petten (NL); Louis David Berkeveld, Petten (NL)

(73) Assignee: Stichting Energieonderzoek Centrum Nederland, Petten (NL)

(21) Appl. No.: 15/756,088

(22) PCT Filed: Sep. 1, 2016
(86) PCT No.: PCT/EP2016/070603

§ 371 Date: Feb. 28, 2018

(30) Foreign Application Priority Data
Sep. 1, 2015 (NL) 2015381

(51) Int. Cl. B22F 1/00; B22F 3/105

(52) U.S. Cl. CPC B22F 1/0074; B22F 3/1055; B22F 2304/052; B33Y 10/00; B22F 2304/056; B22F 2003/1058; B22F 2304/054

(57) ABSTRACT

Additive manufacturing apparatus and method for producing an object layer by layer. The apparatus has a slurry applicator (5) for providing a layer of slurry (3) with a predetermined thickness (d1). The slurry (3) is a suspension containing a liquid and particles eventually forming the object, and has between 10 and 70 volume % of particle content. A particle connection unit (7) is operative on the layer of slurry (3) to execute a single step particle connection process before applying a new layer of the slurry (3).

### FIELD OF THE INVENTION

The present invention relates to an additive manufacturing method for producing an object layer by layer using melting or sintering of particles, and in a further aspect to an additive manufacturing apparatus for producing an object layer by layer.

### PRIOR ART

International patent publication WO98/24574 discloses selective laser sintering at melting temperature, providing a layer-by-layer additive manufacturing process of an object. A laser is used to melt selected parts of a layer of metal particles to form the object layer by layer.

US patent publication US2006/119017 discloses a method for making a ceramic or cermet work piece. A layer of slurry (thin green layer) is deposited and then heated and dried (e.g. by infrared light) to form a hardened thin green layer. After drying the hardened layer of resulting material, the ceramic particles are bonded locally (and to the previous layer) using a high energy beam, e.g. a laser beam.

European patent publication EP-A-1 266 878 discloses a method for making ceramic objects using a fluid suspension. The invention is specifically directed at ceramic objects, as such material is deemed more difficult to handle in additive manufacturing methods than normally used materials such as plastics or metals. The disclosed method includes using a slurry to build a green body followed by drying an applied layer, and laser sintering the left over material. Drying is limited to less than 100 degrees Celsius for the first layer, but may be raised for subsequent layers, and further aided by radiation heating from above

### SUMMARY OF THE INVENTION

The present invention seeks to provide an improved method for additive manufacturing based on laser melting or sintering of particles.

According to the present invention, a method according to the preamble defined above is provided, the method comprising applying a slurry as a layer to be processed (e.g. on a substrate), wherein the slurry is a suspension containing a liquid and particles eventually forming the object, and wherein the slurry has between 10 and 70 volume % of particle content, and executing a particle connection process before applying a new layer of the slurry, wherein the particle connection process is a single step process. The slurry may be implemented as a paste, dispersion, suspension, etc. (depending on the further liquid and or additives used). The indicated range of particle content allows additive manufacturing of a three dimensional object by repeatedly applying a stable, fresh layer on already formed layers of the object. It also allows to have a very homogenous layer to be processed, as well as a stable dispersion of the particles eventually forming the object. Furthermore, splattering of powder during the layer forming process is effectively prevented.

In a further embodiment, the particle connection process is a (laser) melting or a (laser) sintering process. Using such a process allows full melting and solidification of the layer, but would also allow to obtain an open structure of the layer. When using laser as particle connection process implementation, a pulsed or CW laser may be used, which would also allow to use a numerically controlled guidance over the surface of the layer.

In a further embodiment, the particles have a diameter of less than 300 μm, e.g. less than 5 μm. Micro-particles (diameter in the order of 1 μm) or even nano-particles (diameter in the order of 1 nm), may effectively be used. The slurry is a suspension containing a liquid and particles eventually forming the object, wherein the liquid acts as a suspension (or binding) agent for the particles, such that the slurry is a suspension using e.g. water or an alternative solvent such as toluene.

The particle connection process is preceded by a densification process in a further embodiment, e.g. comprises a heating step. This allows to obtain a higher density in the layer already before the particle connection step, using an energy efficient process.

The particles may be one or more of the group of: metal particles (including semiconductor particles), metal precursor material particles, polymer particles, glass particles. This allows to use a diversity of materials for manufacturing the three dimensional object.

In a further embodiment, the slurry further comprises additives, e.g. to enhance the particle connection (sintering) step.

The layer to be processed has a thickness of less than 300 μm in an even further embodiment, allowing to manufacture a three dimensional object with a high accuracy.

In a further embodiment, the method further comprises providing a flow of protective gas on top of the layer to be processed, at least during the particle connection process. In certain circumstances this may be helpful in a proper execution of the particle connection step, and possible the other steps of the present invention methods.

The particle connection process is applied in a predetermined pattern in a further embodiment, allowing to use fine structures in each layer of the additive manufacturing process.

The particle connection process is followed by a rinsing process in a further embodiment. As there still may be some liquid content of the slurry remaining, the non-used material can be easily rinsed away, and also allows to re-use the particles in the slurry.

Different slurry compositions may be used for a new layer of the object, which would allow to obtain a three dimensional object with a graded structure.

In a further aspect, an additive manufacturing apparatus is provided for producing an object layer by layer, the apparatus comprising a slurry applicator for providing a layer of slurry with a predetermined thickness, wherein the slurry is a suspension containing a liquid and particles eventually forming the object, the slurry having between 10 and 70 volume % of particle content; and a particle connection unit operative on the layer of slurry to execute a single step particle connection process before applying a new layer of the slurry. Such an apparatus would eliminate the need of a special operating environment as currently needed for many forms of SLM/SLS apparatus using a protective environment. The apparatus may further comprise a control unit connected to the slurry applicator, an optional densification unit, and the particle connection unit, wherein the control unit is arranged to execute the steps of any of the present invention method embodiments.

### SHORT DESCRIPTION OF DRAWINGS

The present invention will be discussed in more detail below, using a number of exemplary embodiments, with reference to the attached drawings, in which

FIG. 1a-c show the various steps of an embodiment of the present invention;

FIG. 2 shows a schematic view of an apparatus according to an embodiment of the present invention.

### DETAILED DESCRIPTION OF EXEMPLARY EMBODIMENTS

In existing Selective Laser Melting (SLM)/Selective Laser Sintering (SLS) processes for additive manufacturing of three dimensional objects (layer-by-layer), the starting product is usually a powder of (metal) particles in a uniform layer, and the metal particles are melted or sintered together selectively. Existing processes have a minimum layer thickness in the order of 30 μm, and need a protective environment (e.g. by supplying an inert gas above the powder surface) to obtain good results. Thinner layers are difficult to achieve while maintaining sufficient uniformity of the layer. In this case, but also when processing thicker layers, it is possible that due to local overheating unprocessed powder is splashing away during the process. Also, in general, the resulting surface of the processed layer is still quite coarse (due to the grain size of the particles and the melting process) and anisotropic (due to the local melting, resulting in stress and orientation in the microstructure). Also, the process is quite restricted in view of the form of the eventual product, as it is possible that powder not melted is enclosed in the object during the melting process, which cannot be removed afterwards. E.g. fine channels are difficult to make using a regular SLM/SLS process. Furthermore, each object manufactured needs post-processing, e.g. by sandblasting, tumbling or manual sanding/polishing in order to remove clustered powder debris and to improve the surface quality of the object.

According to the present invention embodiments, a different process is provided, wherein the starting material is not a powder of particles, but a suspension containing a liquid and particles eventually forming the object, i.e. a slurry. Using a suspension, e.g. of metal particles suspended in a liquid such as water, allows to properly stack the particles before they are being connected to each other to a uniform layer using e.g. laser melting or laser sintering.

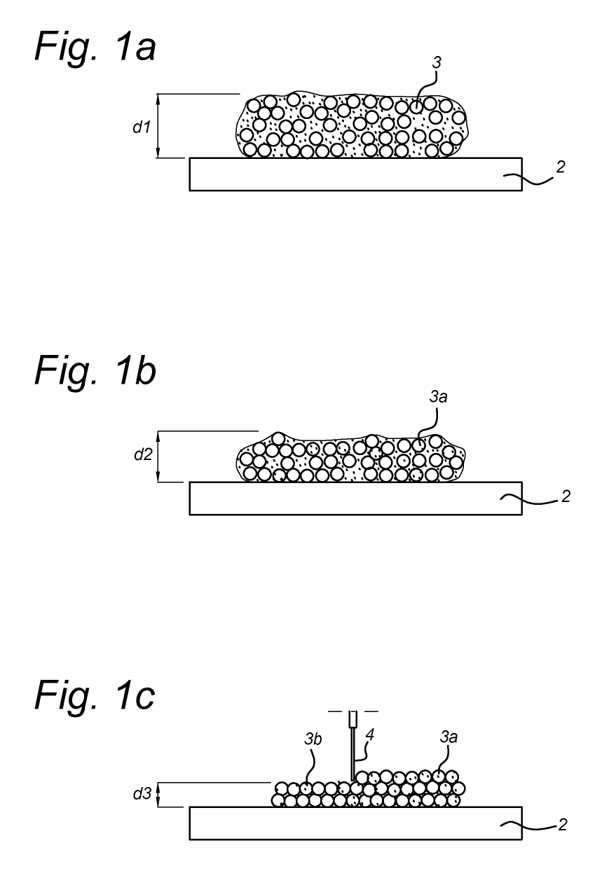

FIG. 1a-c show the steps of an embodiment of the present invention method for producing an object layer by layer, wherein an amount of slurry 3 is deposited onto a substrate 2 (or other suitable surface, e.g. the surface of a previously produced layer), as a layer 3 to be processed. The layer 3 has a thickness d1 of e.g. 40 μm with a particle content of 33 volume % (FIG. 1a). The slurry comprises particles and has between 10 and 70 volume % of particle content, e.g. at least 35 volume % of particle content. The particles in the slurry are e.g. metal particles, or precursors thereof, but can also be polymer particles, glass particles, or even ceramic particles. The slurry is e.g. prepared as a suspension (e.g. metal particles in a liquid such as water), dispersion, or paste, but may also be prepared using sol/gel techniques, depending on the type of particles used. In practical applications, the initial slurry e.g. has a particle content of 50%, which will result in a good densification (stacking of particles) in the following steps.

In FIG. 1b, the situation is shown after an optional processing step, which comprises executing a densification process of the applied slurry layer 3. In this exemplary embodiment, the resulting layer 3a has about 66 volume % of particle content (all particles are neatly stacked, which in case of spherical particles would result in about 66% of particle content). In case of less than fully spherical particles this processing step could already result in (much) less than about 70% of the volume of the initial layer 3 remaining. In the exemplary example shown, the resulting thickness d2 of the layer 3a after the densification process is then 20 μm (going from 33 volume % of particles to 66 volume % of particles). Note that this process also further aids in aligning (or stacking) the particles, which provides a better starting point for the final step of the present method embodiment.

FIG. 1c shows the situation during the particle connection process, wherein the resulting layer 3b is formed using a beam 4 of localized high energy radiation. This will result in an even further densification, e.g. when melting all the particles and allow the material to flow together. The resulting layer 3b e.g. has a thickness d3 of only 13.3 μm in this example, after reaching a density of e.g. 99 volume % of solid material from the particles. Even higher reduction of the layer thickness may be reached, e.g. 99.99 volume %. It is noted that the particle connection process is executed before applying a new layer of the slurry 3, and that the particle connection process is a single step process. As an alternative, this particle connection process may be implemented to provide a resulting layer 3b in the form of a porous layer.

This last step (the particle connection process) is e.g. executed using a selective (laser) melting (or sintering) step.

Using a slurry with between 10 and 70% of particle content allows additive manufacturing of an object by applying stable, fresh layers of slurry on already formed layers of the object, and it also allows to have a very homogenous layer to be processed, resulting in a stable dispersion and proper alignment during the method steps, eventually resulting in an object with very good object characteristics (such as invisible layer structure).

The (solid) particles in the slurry 3 have a diameter of less than 300 μm, but may even be as small as 5 μm, or even in the order of 1 μm (micro-particles) or 1 nm (nano-particles), in the present invention embodiments. This allows to obtain a processed layer 3b of a desired thickness, and even thin layers 3b of 10 μm thickness or even less, resulting in three dimensional objects with a higher resolution and a better microstructure.

In a further embodiment the slurry 3 comprises a suspension (or binding) agent for the particles, e.g. using water or alternative solvents such as toluene to provide the suspension of (metal) particles. This enhances the cohesion between the particles in the slurry 3, resulting in better alignment of the particles.

The densification process (see FIG. 1b) provides an intermediate layer 3a having e.g. 66% or even as much as 95% of particle content. The densification process comprises e.g. a heating step. Heating can be applied to the amount of slurry 3 on the substrate 2 in a very efficient manner using various techniques of direct or indirect heating, and can effectively enlarge the particle content of the resulting intermediate layer 3a.

The particle connection process (see FIG. 1c) may provide an object built layer by layer having at least 98% of solid material (particle) content, e.g. at least 99.99%, i.e. a very uniform layer 3b. This particle connection process is e.g. a (laser) melting or a (laser) sintering process. Such a SLM or SLS process is known as such, and can provide for a very efficient particle connection step.

The present invention embodiments may be applied to obtain an object of a range of materials, by having the particles to be one or more of the group of: metal particles, metal precursor material particles, polymer particles, ceramic particles, glass particles. Examples of metal precursor material particles include but are not limited to metal hydride particles, metal oxide particles, metal hydroxide particles, metal sulfide particles, metal halide particles, metal organic compound particles or other mineral particles. The metal particles can be titanium, tungsten, etc., but may also be semiconductor material particles, such as silicon, germanium, etc.

When using metal precursor material particles, these have to be processed, e.g. using reduction with a reducing agent like carbon, hydrogen, hydrides, alkali metals such as Na or Mg, or by electrochemical way. In this manner (part of) the metal can be formed out of metal precursor material particles, resulting in an additional densification or an internal reducing environment during metal formation. This will enhance in a higher quality material of the object thus manufactured. The precursor material processing step may be a separate step, or (partly) executed with the densification step and/or the particle connection step.

When using particles of a material with appropriate thermal characteristics, these can also be used using the present invention embodiments, e.g. to provide a glazing or enamel layer.

The slurry 3 may further comprise additives to further enhance one or more steps of the present method embodiment, e.g. to enhance a sintering or densification process implementation of the particle connection process. E.g. (sub-) nano sinter-active metal parts may be provided at intermediate stages, which can enhance the entire sintering process. Furthermore, the slurry 3 may also comprise mixtures of metal or other particles, in order to provide a layer (and additive manufactured object) of an alloy material. Also, the slurry 3 may comprise a main particle material, and in a smaller amount a secondary particle material, e.g. to obtain an yttrium doted object. Such a secondary particle material can easily be added to the slurry using a suitable liquid medium.

As the present invention embodiments use a slurry with suspended particles, it is possible to obtain very thin layers in the eventual object. E.g. as exemplified above with reference to FIG. 1a-c, the layer of slurry 3 to be processed has a thickness d1 of less than 40 μm, eventually resulting in a processed layer 3b of only 10 μm thick. In further examples, the starting layer 3 may be thicker, even up to 300 μm. Even when using micro-particles in the slurry 3, the layer of slurry to be processed is manageable in terms of accuracy and homogeneity/uniformity of the layer.

In a further embodiment, the method further comprises providing a flow of protective gas on top of the layer of slurry 3 to be processed at least during the particle connection process (but also during the (optional) densification process). This can further enhance the quality of the layers formed using these methods, especially when e.g. the metal particles used are possibly reacting with a normal atmosphere environment.

The particle connection process is applied in a predetermined pattern in an even further embodiment. This allows to obtain fine structures in each layer for additive manufacturing of objects. To further enhance this and other embodiments, the particle connection process is followed by a rinsing process in a further embodiment. As the material remaining after the particle connection process still has some slurry like characteristics (as not all solvent/water in the slurry is evaporated), it is possible to rinse the object just processed to remove untreated parts of the last applied layer. This further enhances the ability to provide fine structures and features in the three dimensional object produced using the present invention embodiments. Furthermore, it easily allows to recuperate and reuse the particles left, for making a further amount of slurry.

In even further embodiments, the method further comprises using different slurry compositions for a new layer of the object. This may advantageously be used for obtaining graded structures in the three dimensional object, or to provide e.g. a local membrane (even having a structured texture) within a dense object. Even further layer deposition techniques may be used intermittently with the densification/particle connection steps described above, e.g. using a slurry with a curable resin to provide one or more layers of a different material.

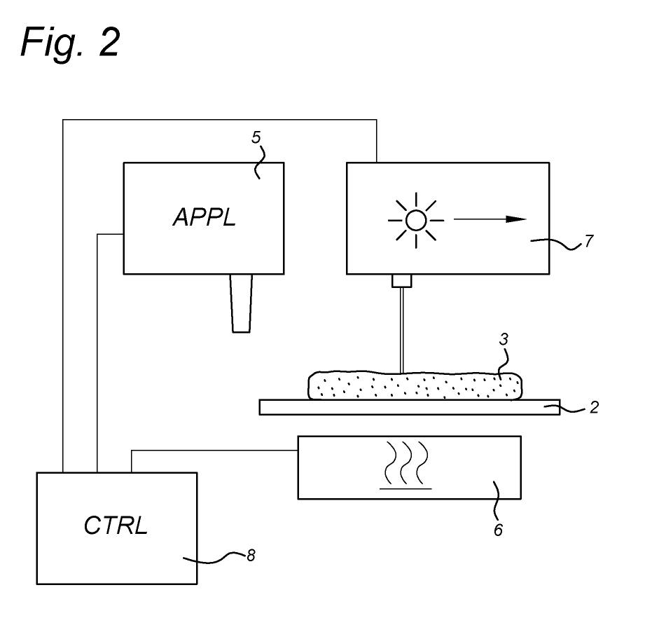

The above described method embodiments may be implemented using an additive manufacturing apparatus for producing an object layer by layer. As shown in the schematic view of an embodiment of the present invention apparatus as shown in FIG. 2, the apparatus comprises a slurry applicator 5 for providing a layer of slurry 3 (or suspension, paste, dispersion) with a predetermined thickness d1, wherein the slurry is a suspension containing a liquid and (solid) particles eventually forming the object, the slurry 3 having between 10 and 70% of particle content. Furthermore, an (optional) densification unit 6 is present which is operative on the layer of slurry 3, as well as a particle connection unit 7 also operative on the layer of slurry 3 (subsequent to the densification unit 6 if present) to execute a single step particle connection process before applying a new layer of the slurry 3. In this apparatus, no special environment is needed, as opposed to prior art SLM/SLS systems which need a protective environment around the laser melting/sintering point to prevent splashing of the powdered material.

As shown in the embodiment in FIG. 2, the densification unit 6 may be a heating device and the particle connection unit 7 is a laser device. The laser device can be a pulsed or continuous wave laser, using e.g. a solid state or a semiconductor (diode) laser. The particle connection unit 7 may be arranged to apply the energy on a specific small point in order to execute the melting/sintering process. E.g. using a CNC controlled laser source, the entire surface of the layer 3 can be exposed to a (patterned) dose of radiation.

Furthermore, the additive manufacturing apparatus may further comprise a control unit 8 connected to the slurry applicator 5, densification unit 6 and particle connection unit 7. The control unit 8 is in this embodiment arranged to execute the method according to any one of the embodiments described above. This allows to automatically control the entire process for additive manufacturing of a three dimensional object. Further alternatives in relation to the control unit 8 could be that the control unit is also connected to the substrate 2 (directly or indirectly via e.g. a stage) for controlling the height position (or even also the x-y position) of the fresh layer 3a for the particle connection process (laser melting/sintering) for subsequent layers of the three dimensional object being manufactured.

The present invention embodiments have been described above with reference to a number of exemplary embodiments as shown in the drawings. Modifications and alternative implementations of some parts or elements are possible, and are included in the scope of protection as defined in the appended claims.

1. An additive manufacturing method for producing an object layer by layer, the method comprising
applying a slurry as a layer to be processed, wherein the slurry is a suspension containing a liquid and particles eventually forming the object, and wherein the slurry has between 10 and 70 volume % of particle content, and
executing a particle connection process before applying a new layer of the slurry,
wherein the particle connection process is a single step process.

2. The method according to claim 1, wherein the particle connection process is a melting or a sintering process.

3. The method according to claim 1, wherein the particles have a diameter of less than 300 μm.

4. The method according to claim 1, wherein the particle connection process is preceded by a densification process.

5. The method according to claim 1, wherein the particles are one or more of the group of: metal particles, metal precursor material particles, polymer particles, glass particles.

6. The method according to claim 1, wherein the slurry further comprises additives.

7. The method according to claim 1, wherein the layer to be processed has a thickness of less than 300 μm.

8. The method according to claim 1, further comprising providing a flow of protective gas on top of the layer to be processed at least during the particle connection process.

9. The method according to claim 1, wherein the particle connection process is applied in a predetermined pattern.

10. The method according to claim 1, wherein the particle connection process is followed by a rinsing process.

11. The method according to claim 1, further comprising using different slurry compositions for a new layer of the object.

12. An additive manufacturing apparatus for producing an object layer by layer, the apparatus comprising
a slurry applicator for providing a layer of slurry with a predetermined thickness, wherein the slurry is a suspension containing a liquid and particles eventually forming the object, the slurry having between 10 and 70 volume % of particle content; and
a particle connection unit operative on the layer of slurry to execute a single step particle connection process before applying a new layer of the slurry.

13. The apparatus according to claim 12, further comprising a densification unit, operative on the layer of slurry before the particle connection unit.

14. The apparatus according to claim 12, wherein the particle connection unit is a laser device.

15. The apparatus according to claim 12, further comprising a control unit connected to the slurry applicator, and the particle connection unit.

16. The method according to claim 3, wherein the particles have a diameter of less than 5 μm.

17. An additive manufacturing apparatus for producing an object layer by layer, the apparatus comprising
a slurry applicator for providing a layer of slurry with a predetermined thickness, wherein the slurry is a suspension containing a liquid and particles eventually forming the object, the slurry having between 10 and 70 volume % of particle content;
a densification unit operative on the layer of slurry;
a particle connection unit operative on the layer of slurry to execute a single step particle connection process before applying a new layer of the slurry; and
a control unit connected to the slurry applicator, the densification unit and the particle connection unit, wherein the control unit is arranged to execute the method according to claim 1.

18. The method according to claim 2, wherein the particle connection process is a laser melting or a laser sintering process.
